(19) United States
(12) Patent Application Publication
(10) Pub. No.: US 2009/0042637 A1
(43) Pub. Date: Feb. 12, 2009

(54) Method of playing a slot machine with connected payline positions

(76) Inventors: Anthony Singer, Ramsey, NJ (US); T. Grant Bolling, Mahwah, NJ (US); Daniel Mordecai Marks, Cold Spring, NY (US)

Correspondence Address: PTT LLC (D/B/A HIGH 5 GAMES), 1200 MACARTHUR BLVD, MAHWAH, NJ, 07430, US

(21) Appl. No.: 12/221,658

(22) Filed: Aug. 5, 2008

Related U.S. Application Data
(60) Provisional application No. 60/963,749, filed on Aug. 6, 2007.

(51) Int. Cl. A63F 13/00

(52) U.S. Cl. 463/20

(57) ABSTRACT

The present invention defines connected pay lines in a symbol matrix by using combinations of connected symbol positions in a symbol matrix. The term “connected symbol positions” refers to symbol positions that are adjacent to each other in the symbol matrix; the term “connected pay lines” refers to a pay line comprised of connected symbol positions.

### PRIORITY CLAIM

This application is a non-provisional patent application that claims priority to and the benefit of U.S. Provisional Patent Application Ser. No. 60/963,749, filed Aug. 6, 2007, incorporated herein by reference.

### COPYRIGHT NOTICE

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF INVENTION

In general, the present invention relates to new methods of operating a slot machine game and, in particular, relates to new methods of defining pay lines in the symbol matrix of a slot machine game.

### BACKGROUND OF THE INVENTION

To play a conventional slot machine, the player deposits money into the machine, sets the wager, and spins the reels. When the reels stop spinning, the player collects credits for winning symbol combinations displayed on the reels, if any, according to a predetermined pay schedule.

While the appearance of conventional slot machines may change from one theme, such as space aliens, to another theme, such as farm animals, the underlying methods of play—setting the wager, spinning the reels, collecting awards—remain the same from machine to machine.

The many similarities of conventional slot machines limit the value of the slot machine games for players, casinos, and manufacturers. Players tire of the same methods of play; casinos cannot distinguish their games from other casinos; and manufacturers cannot distinguish their products from other manufacturers.

Thus, new methods of playing slot machine games are required to enhance the value of these games to players, casinos, and manufacturers, including better methods of defining pay lines and illustrating winning combinations appearing on said pay lines.

### SUMMARY OF THE INVENTION

The present invention defines connected pay lines in a symbol matrix by using combinations of connected symbol positions in a symbol matrix. In general, the term “connected symbol positions” refers to symbol positions that are adjacent to each other in the symbol matrix; the term “connected pay lines” refers to a pay line comprised of connected symbol positions.

More specifically, symbol positions A(a1,a2) and B(b1,b2) in a symbol matrix formed by a plurality of n rows intersecting with a plurality of m columns, would be defined as:

‘Connected’ if: 1) A is not the same as B, i.e., either a1< >b1 or a2< >b2 or both; 2) A and B are within one row of each other, i.e., the difference between a2 and b2 is less than or equal to 1 (Abs(a2−b2)<=1); and 3) A and B are within one column of each other, i.e., the difference between a1 and b1 is less than or equal to 1 (Abs(a1−b1)<=1).

‘Simply connected horizontally’ if: 1) A and B are connected as defined above; and 2) A and B are not in the same column, i.e., it is further required that a2< >b2.

A pay line, P, is a ‘connected pay line’ if it is a non-empty subset of the symbol matrix formed by an ordered set of n many symbol positions {A(1), A(2), . . . , A(n)} where: 1) n is larger than 1; and 2) for a(i) and a(j) elements in P, A(i)=A(j) if and only if i=j such that there are no repeated elements in the path; 3) A(1) is connected to A(2); 4) A(n−1) is connected to A(n); and 5) for any A(i) in P where 1<i<n, A(i) is connected to both A(i−1) and A(i+1).

A pay line, P, is ‘horizontally simply connected’ if: 1) P is a connected pay line; 2) A(1) is simply connected horizontally to A(2); 3) A(n−1) is simply connected horizontally to A(n); 4) for any A(i) in P where 1<i<n, A(i) is simply connected horizontally to both A(i−1) and A(i+1). The definition of a vertically simply connected pay line should be readily apparent.

A pay line, P, is defined to be ‘horizontally complete’ if P contains at least one element from each column in the symbol matrix or, more formally, for a symbol matrix formed by n rows and m columns, A={a(i,j)} 1<=i<=n, 1<=j<=m, there is a subset of P, P′, not necessarily connected, such that given any j where 1<=j<=n, there exists some element a(i,j) in P′.

A complete horizontally simply connected pay line would be any path that satisfies the conditions of being horizontally complete and horizontally simply connected. The definitions of vertically complete and complete vertically simply connected should be apparent.

For example, a 3 by 5 symbol matrix where the symbol position in the upper left corner of the matrix is represented by (1,1) and the symbol position in the bottom right corner of the symbol matrix is said to be (3,5), the ordered collection {(1,1), (1,2), (2,3), (3,4), (2,5)} is a complete horizontally simply connected pay line.

A preferred embodiment of the present invention defines all complete horizontally simply connected pay lines across a matrix of any number of rows and columns. In one instance of the preferred embodiment, a symbol matrix with 5 columns and 3 rows results in 99 complete horizontally simply connected pay lines. The chart below lists the number of complete horizontally simply connected pay lines across symbol matrices of varying numbers of rows and columns:

| | | Number of Columns | | | | | | | | |
|---|---|---|---|---|---|---|---|---|---|---|
| | | 1 | 2 | 3 | 4 | 5 | 6 | 7 | 8 | 9 |
| Num- | 1 | 1 | 1 | 1 | 1 | 1 | 1 | 1 | 1 | 1 |
| ber | 2 | 2 | 4 | 8 | 16 | 32 | 64 | 128 | 256 | 512 |
| of | 3 | 3 | 7 | 17 | 41 | 99 | 239 | 577 | 1393 | 3363 |
| Rows | 4 | 4 | 10 | 26 | 68 | 178 | 466 | 1220 | 3194 | 8362 |
| | 5 | 5 | 13 | 35 | 95 | 259 | 707 | 1931 | 5275 | 14411 |
| | 6 | 6 | 16 | 44 | 122 | 340 | 950 | 2658 | 7442 | 20844 |
| | 7 | 7 | 19 | 53 | 149 | 421 | 1193 | 3387 | 9627 | 27383 |
| | 8 | 8 | 22 | 62 | 176 | 502 | 1436 | 4116 | 11814 | 33942 |
| | 9 | 9 | 25 | 71 | 203 | 583 | 1679 | 4845 | 14001 | 40503 |
| | 10 | 10 | 28 | 80 | 230 | 664 | 1922 | 5574 | 16188 | 47064 |

An alternative embodiment of the present invention defines all complete vertically simply connected pay lines across a matrix of any number of rows and columns.

Another alternative embodiment of the present invention defines all simply connected pay lines across a matrix of any number of rows and columns.

### BRIEF DESCRIPTION OF THE DRAWINGS

The accompanying figures illustrate various stages of the preferred embodiment of the present invention:

FIG. 1 shows complete horizontally simply connected pay lines 01 to 30 in a 3-row by 5-column symbol matrix.

FIG. 2 shows complete horizontally simply connected pay lines 31 to 60 in a 3-row by 5-column symbol matrix.

FIG. 3 shows complete horizontally simply connected pay lines 61 to 90 in a 3-row by 5-column symbol matrix.

FIG. 4 shows complete horizontally simply connected pay lines 91 to 99 in a 3-row by 5-column symbol matrix.

FIG. 5 shows a game screen with a winning symbol combination appearing on a complete horizontally simply connected pay line.

### DESCRIPTION OF A PREFERRED EMBODIMENT

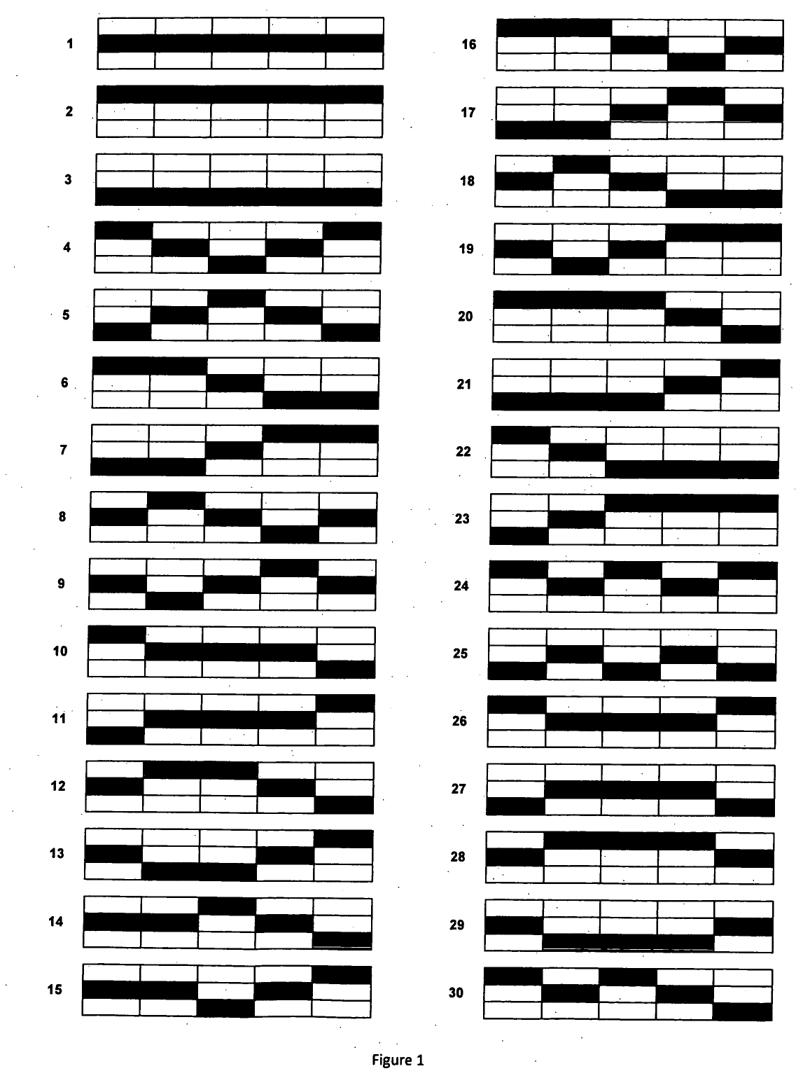

To play a preferred embodiment of the present invention, the player initializes credits, selects the number of complete horizontally simply connected pay lines, sets the wager per complete horizontally simply connected pay line, spins the reels, and collects awards for winning symbol combinations, as detailed below with reference to FIGS. 1 through 5 (collectively “the Figures”):

Initialize Credits. In the Figures, the player initializes credits by depositing money in the form of coins, gaming tokens or paper currency into a coin head (not shown) or bill acceptor (not shown). Coins and gaming tokens are collected in a reservoir (not shown) inside the gaming machine; paper currency is collected in the bill acceptor (not shown) inside the gaming machine.

If the coins, gaming tokens or paper currency are validated as authentic, the player accrues the appropriate number of playing credits on the Credit meter 116. More credits may be initialized, if necessary, by additional deposits. Alternatively, any method of initializing credits may be used including debit cards, credit cards, or other form of electronic funds transfer.

Select the Number of Complete Horizontally Simply Connected Pay Lines. In the Figures, the player selects the number of complete horizontally simply connected pay lines upon which to wager. The player may select from 1 to 99 complete horizontally simply connected pay lines defined across the 3-row by 5-column symbol matrix 190. To select complete horizontally simply connected pay lines, the player uses the Select Pay Lines button 108 and views the number of selected pay lines on the Select Pay Lines meter 118.

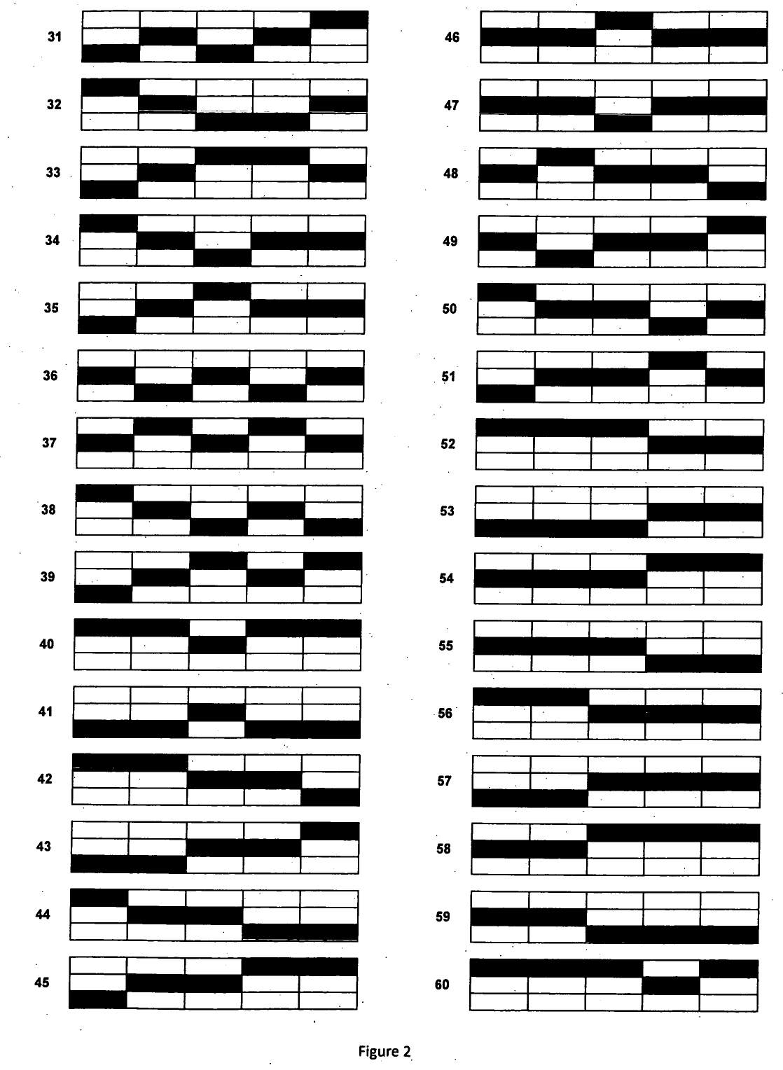

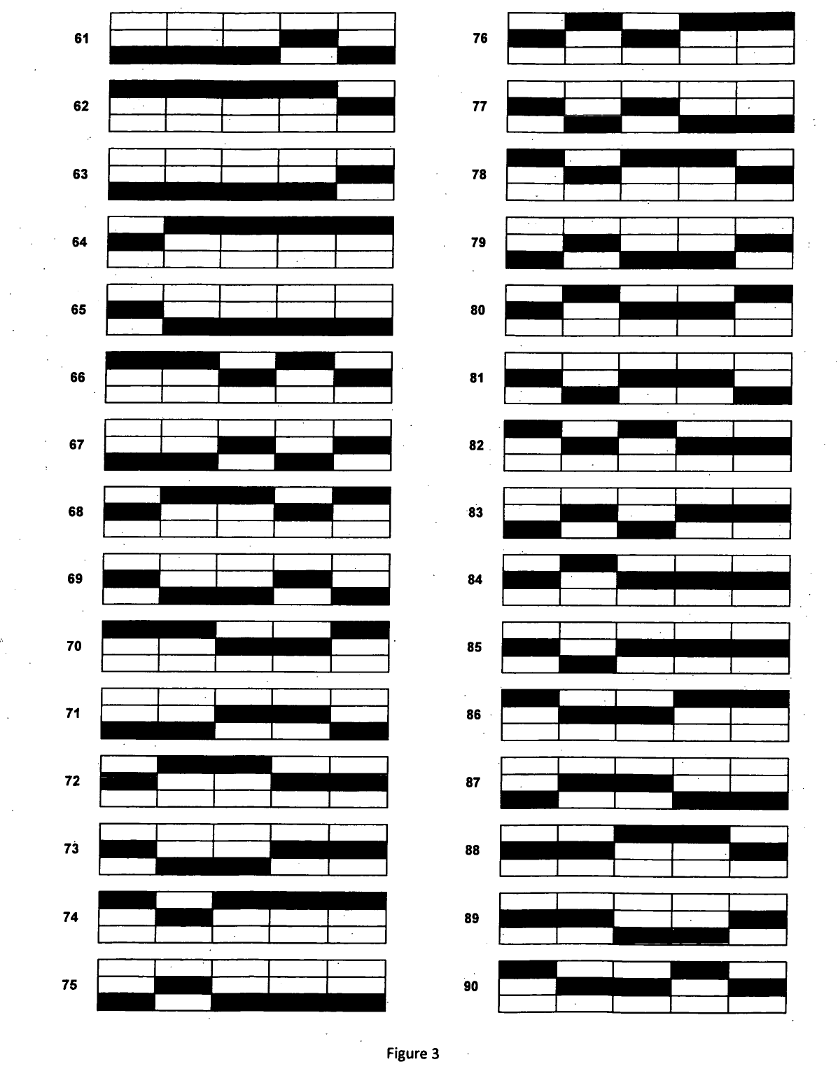

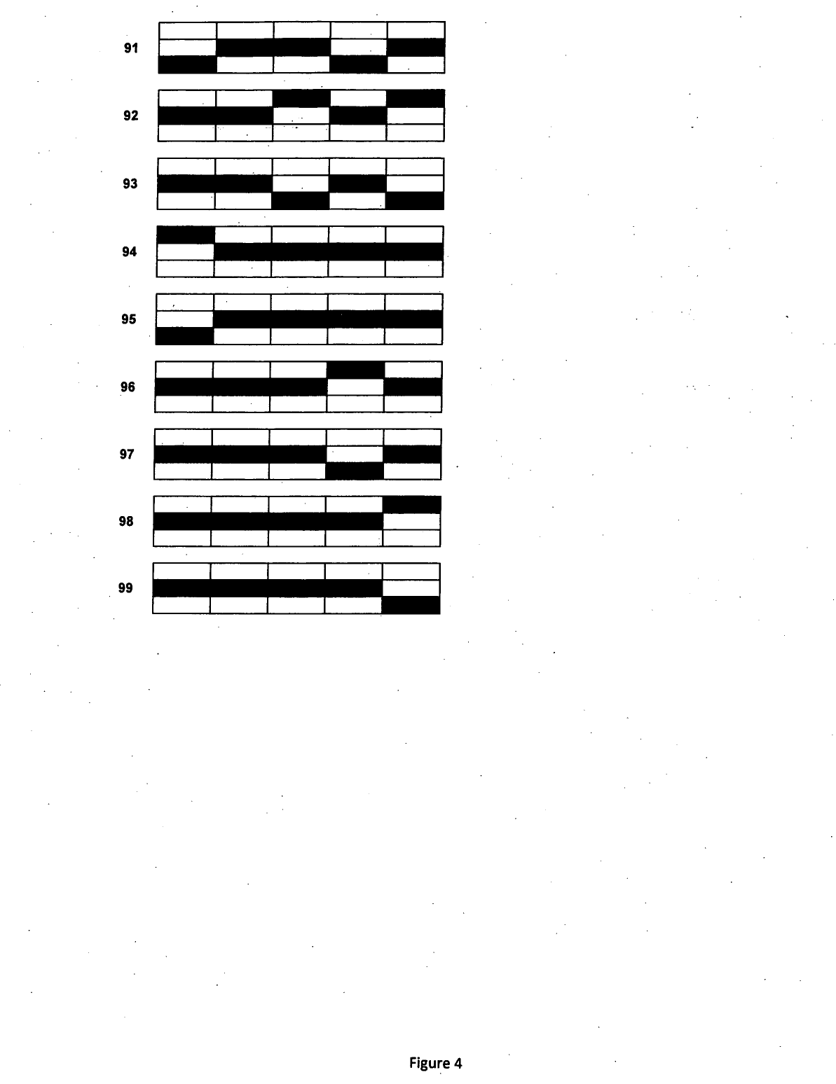

The complete horizontally simply connected pay lines must be selected in accordance with a predetermined order (i.e. pay line 1 is selected first, pay line 2 is selected second, and pay line N in selected Nth). FIGS. 1 to 5 illustrate the specific predetermined order of the complete horizontally simply connected pay lines and the defined path of each said pay line across symbol matrix 190:
FIG. 1 shows the paths for complete horizontally simply connected pay lines 1 to 30;
FIG. 2 shows the paths for complete horizontally simply connected pay lines 31 to 60;
FIG. 3 shows the paths for complete horizontally simply connected pay lines 61 to 90; and
FIG. 4 shows the paths for complete horizontally simply connected pay lines 91 to 99;

By selecting 99 complete horizontally simply connected pay lines, the player selects all possible complete horizontally simply connected pay lines in the 3-row by 5-column symbol matrix 190.

Setting the Wager Per Complete Horizontally Simply Connected Pay Line. In the Figures, the player sets the bet per complete horizontally simply connected pay line. The player may wager from 1 to N credits per selected complete horizontally simply connected pay line. To set the bet per complete horizontally simply connected pay line, the player uses the Bet Per Pay Line button 110 and views the amount bet per pay line on the Bet Per Pay Line meter 120. The same amount is wagered on each complete horizontally simply connected pay line. For example, five credits may be wagered on each complete horizontally simply connected pay line. Alternatively, the player may wager a single credit upon a group of two or more complete horizontally simply connected pay lines, with a fraction of the credit allocated to each of the selected complete horizontally simply connected pay lines.

The total wager is then calculated by multiplying the number of selected complete horizontally simply connected pay lines by the bet per complete horizontally simply connected pay line. For example, the player wagers five credits on each of nine complete horizontally simply connected pay lines for a total bet of forty-five credits. The total bet amount is displayed on the Total Bet meter 122.

In addition to using the Select Pay Lines button 108 and Bet Per Pay Line button 110, the player may also use the Bet Max button 112 to place the maximum bet per complete horizontally simply connected pay line on all of the complete horizontally simply connected pay lines. Alternatively, any wager may be assigned a button.

Spin the Reels. In the Figures, the player uses the Spin button 114 to randomly rearrange the symbols displayed in the symbol matrix 190. The symbol matrix 190 contains three symbol positions for each of the five slot reels 156-164 for a total of fifteen symbol positions 126-154. Alternatively, any number of reels with any number of symbol positions may be used.

The slot reels 156-164 spin and randomly stop one reel at-a-time, from left to right, until all five reels have stopped and all fifteen symbol positions 126-154 of the symbol matrix 190 are revealed. Alternatively, any size symbol matrix may be used and any method may be used to rearrange symbols in the symbol matrix.

Winning Symbol Combinations. The player receives awards for winning symbol combinations formed by two or more, same, adjacent symbols, starting from the leftmost position of a complete horizontally simply connected pay line. For example, four “8” symbols (i.e. 8-8-8-8) appearing on a selected complete horizontally simply connected pay line is a winning symbol combination with an award of 10× the bet per line.

The player may also receive awards for winning symbol combinations appearing on a selected complete horizontally simply connected pay line that uses wildcard symbols. For example, three “8” symbols and a wildcard symbol (“W”) acting as an “8” symbol (i.e. 8-8-8-W) appearing on a selected complete horizontally simply connected pay line is a winning symbol combination with an award of 10× OX the bet per line.

The use of a wildcard symbol to form a winning symbol combination does not affect the award value. For example, the winning combinations 8-8-8-8 and 8-8-8-W both award the same 10× the bet per line award. Alternatively, wildcard symbols and/or expanded wildcard symbols may affect the award value of winning combinations.

All winning symbol combinations, including combinations with and without wildcard symbols, are listed on a predetermined pay schedule (not shown) along with their award values. The player may view the pay schedule (not shown) by pressing the Pays button 104. In addition, the player may press the Help button 106 to view the rules of the game (not shown).

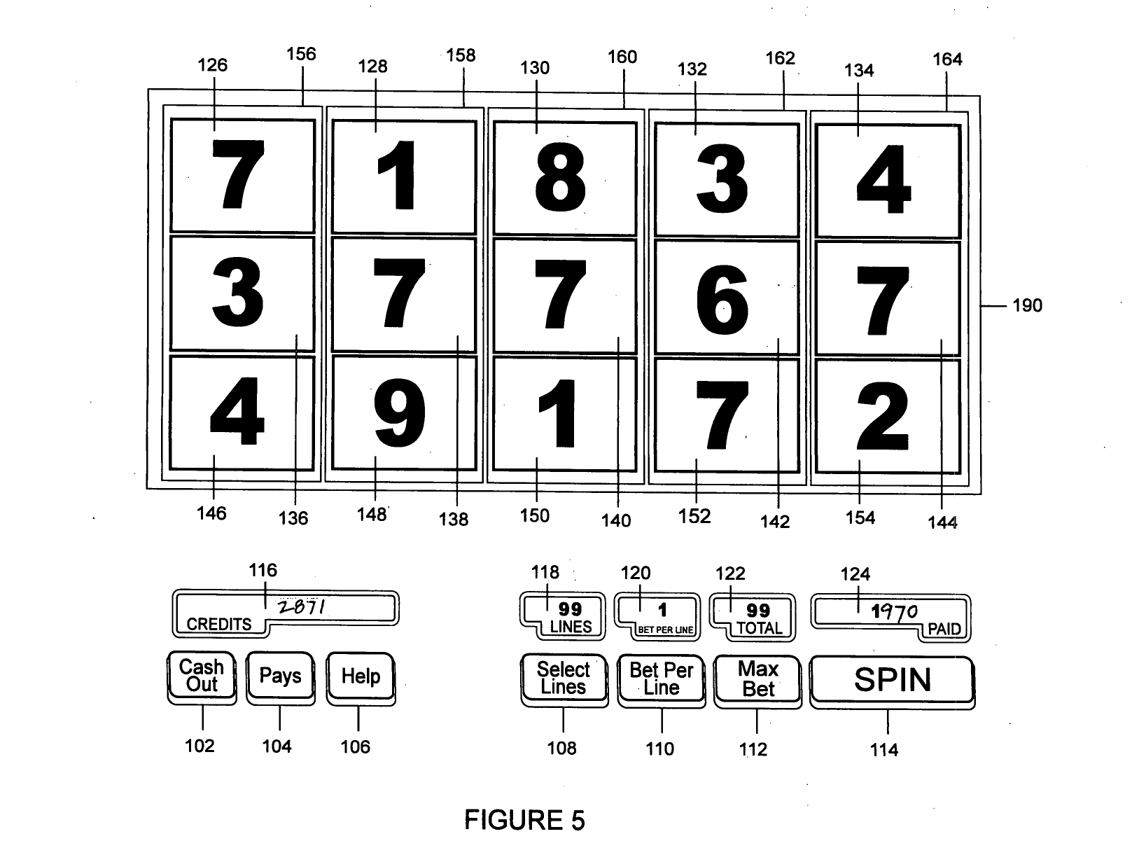

In FIG. 5, a winning symbol combination of “7-7-7-7-7” appears on a selected complete horizontally simply connected pay line. The first “7” symbol appears in the top position 126 of the first column 156, the second “7” symbol appears in the middle position 138 of the second column 158, the third “7” symbol appears in the middle position 140 of the third column 160, the fourth “7” symbol appears in the bottom position 152 of the fourth column 162 and the fifth “7” symbol appears in the middle position 144 of the fifth column 164.

Thus, each of the “7” symbols in FIG. 5 appears simply horizontally connected to the adjacent “7” symbols on the complete horizontally simply connected pay line: the first “7” symbol is simply horizontally connected to the second “7”; the second “7” symbol is simply horizontally connected to the first and third “7” symbols; the third “7” symbol is simply horizontally connected to the second and fourth “7” symbols; the fourth “7” symbol is simply horizontally connected to the third and fifth “7” symbols; and the fifth “7” symbol is simply horizontally connected to the fourth “7”.

In FIG. 5, the winning symbol combination of “7” symbols generates a credit award according to a predetermined pay schedule (not shown) for each winning combination of three “7”, four “7” and five “7” symbols appearing on a complete horizontally simply connected pay line, as follows:
There are 7 complete horizontally simply connected pay lines with exactly three “7” symbols appearing on said pay lines, with each winning combination of “7” symbols paying 10 credits in accordance with the predetermined pay table (not shown);
There are 2 complete horizontally simply connected pay lines with exactly four “7” symbols appearing on said pay lines, with each winning combination of “7” symbols paying 250 credits in accordance with the predetermined pay table (not shown);
There is 1 complete horizontally simply connected pay line with exactly five “7” symbols appearing on said pay lines, with each winning combination of “7” symbols paying 1400 credits in accordance with the predetermined pay table (not shown);

Upon issuance of the total 1970 credit award, the credits are added to the player's balance of credits, as shown on the Credit meter 116. As long as the player has credits remaining on the Credit meter 116, the player may continue to play the gaming machine. The player may also collect the balance of credits by pressing the Cash Out button 102.

### SCOPE & SPIRIT OF THE PRESENT INVENTION

The many features and advantages of the present invention are apparent from the descriptions of the preferred and alternative embodiments. The present invention, however, is not limited to these particular embodiments, as the invention is capable of being practiced and carried out in various ways. For example, new features may be added to an existing embodiment or features from two or more embodiments may be combined to produce a new embodiment. Further, features mentioned in any embodiment may be interchanged with similar features not mentioned that perform the same or similar functions. And, finally, the phraseology and terminology used to explain the embodiments are only descriptive and should not be regarded as limiting. The claims, therefore, seek to cover all features and advantages that fall within the true spirit and scope of the present invention.

We claim:

1. A method of playing a game using a symbol matrix formed by at least one row intersecting with a plurality of columns, with the rows and columns defining a plurality of symbol positions and including a plurality of symbols, comprising:
a. randomly rearranging the plurality of symbols;
b. displaying the rearranged symbols; and
c. issuing awards when predetermined symbol combinations appear in one of a plurality of predetermined combinations of symbol positions, with said combinations of symbol positions comprised of all possible combinations of adjacent symbol positions using one symbol position from each column in the symbol matrix.

2. A method of claim 1 in which said combinations of symbol positions are comprised of all possible combinations of adjacent symbol positions using one symbol position from each row in the symbol matrix.

3. A method of playing a game using a symbol matrix formed by at least one row intersecting with a plurality of columns, with the rows and columns defining a plurality of symbol positions and including a plurality of symbols, comprising:
a. randomly rearranging the plurality of symbols;
b. displaying the rearranged symbols; and
c. issuing awards when predetermined symbol combinations appear in one of a plurality of predetermined combinations of symbol positions, with said combinations of symbol positions comprised of all possible combinations of adjacent symbol positions in the symbol matrix such that for any two adjacent symbol positions, A(a1,a2) and B(b1,b2):
i. A is not the same as B such that either a1< >b1 or a2< >b2 or both;
ii. A and B are within one row of each other such that the difference between a2 and b2 is less than or equal to 1 or Abs(a2−b2)<=1;
iii. A and B are within one column of each other such that the difference between a1 and b1 is less than or equal to 1 or Abs(a1−b1)<=1; and
iv. A and B are not in the same column such that it is further required that a2< >b2.
